(19) United States
(12) Patent Application Publication
(10) Pub. No.: US 2007/0204152 A1
(43) Pub. Date: Aug. 30, 2007

(54) METHOD FOR THE DISTRIBUTION OF CONTENTS

(75) Inventor: Wulf Harder, Riga (LV)

Correspondence Address: VIDAS, ARRETT & STEINKRAUS, P.A., SUITE 400, 6640 SHADY OAK ROAD, EDEN PRAIRIE, MN, 55344, US

(73) Assignee: SIA Syncrosoft, Riga (LV)

(21) Appl. No.: 11/622,143

(22) Filed: Jan. 11, 2007

(30) Foreign Application Priority Data
Feb. 10, 2006 (DE) 10 2006 006 633.2

(51) Int. Cl. H04L 9/00

(52) U.S. Cl. 713/163; 340/7.43; 380/277; 713/176

(57) ABSTRACT

A method for the distribution of a content, characterised in that an encoded content is received by at least two receivers and is decoded with the aid of data blocks which differ from each other, wherein the encoding of the content is not receiver specific or receiver group specific, and the data blocks, the assignment thereof to the receivers and the procedure of the direct decoding of the content are receiver specific or receiver group specific

### CROSS-REFERENCE TO RELATED APPLICATIONS

Not applicable.

### STATEMENT REGARDING FEDERALLY SPONSORED RESEARCH

Not applicable

### BACKGROUND Of THE INVENTION

The present invention is related to a method for the distribution of contents. In the present document, every kind of data is to be understood with the term “content”. This term has been selected because the methods according to the present invention are particularly suited for the distribution of multimedia data. In addition, the term is meant to include contents which are subdivided and possibly transmitted in a chronologically staggered manner, the parts of which can be encoded with different keys. A part of a content can be regarded as a self contained content.

Contents are often symmetrically encoded. The symmetric key is asymmetrically encoded with the public key of the receiver and is transmitted to the receiver together with the content. The receiver decodes this symmetric key asymmetrically with its private key. With the thus obtained symmetric key, the received decodes the content In many cases, the asymmetric decoding takes place in a secured hardware. There also cases in which the decoding of the content takes place in the secured hardware in addition

The symmetric key can be distributed illegally, without that the source of the distribution can be identified. For instance, television stations transmit their program in an encoded form The reception is possible with the aid of decoder devices, which permit the asymmetrical or receiver specific, respectively, decoding of the content key to be performed in a secured hardware However, the symmetric decoding of the content is not receiver specific and takes mostly place in a faster, not secured hardware for reasons of speed Cases are known in which the decoding devices are obviated, the symmetric keys being distributed by a receiver via the internet. When the asymmetric or receiver specific, respectively, and also the symmetric content decoding takes place in a secured hardware, the successful hardware attack against one single device is sufficient to undermine the whole legal content distribution system. All symmetric content-specific keys can be distributed illegally, without that the legal system has a chance to react thereupon.

The present invention is based on the objective to provide a method for the distribution of contents and of data blocks, which serve for the decoding of the content, in which the receiver can be identified after an illegal distribution of a data block, so that the legal distribution system can react upon the illegal distribution.

### BRIEF SUMMARY OF THE INVENTION

The receivers receive a not receiver specific encoded content and receiver specific data blocks, and the direct decoding of the content at the receiver takes place in a receiver specific way. The assignment of the data blocks to the receivers can be made sure by transmission via receiver specific channels, for instance. Also, several receivers can form a group and the decoding of the content may take place in a way which is specific for the receiver group. The data block serves for decoding the content and may contain different subject matters, like a key of a symmetric encoding or a program code for decoding the content or both, for instance. The decoding can also contain a not receiver specific decoding part with a standard algorithm like AES, for instance, provided that the content had been correspondingly encoded with the same algorithm before.

When a receiver distributes a receiver specific data block, then he can be identified by means of this data block and can be prevented from further illegal distribution of contents, for instance

It is prevented that an aggressor tries to make the receiver specific data block anonymous or to change it such that it is to be assigned to another receiver This is achieved when the analysis and the comparison of the functionality of data blocks of plural receivers is made difficult, for instance

The receiver specific data block has the property that it can be identified by an automatic method. Through this, a rapid reaction against illegal distribution of data blocks is made possible.

The encoding method for the content is imparted the property that receiver specific information can be recognised on the basis of its input/output behaviour. It has to be taken into account that an aggressor transforms the decoding method with the aid of obfuscation tools, in order to make the identification of the receiver difficult. This modus operandi makes no sense in the case that receiver specific information can be identified on the basis of the input/output behaviour. For instance, the decoding method might give out plain texts after the input of special test contents, from which receiver specific data can be automatically filtered out

During or directly after decoding, a receiver specific watermark is pasted into the content. The pasting of the watermark at the receiver disburdens the content transmitter, because the same would otherwise have to take over the task of pasting for many receivers. This is particularly sumptuous when the content transmission takes place in real time, like in a television transmission for instance The receiver specific data block can be used in creating the watermark

Data of receivers are stored in a database When an illegally distributed data block is detected, the receiver can be identified with the aid of this database. Through this, receiver-individual reaction against the illegal distribution is made possible. A solution which is an alternative to the feature of claim 6, namely to encode the data which are necessary for identifying the receiver in the data block, is possible.

Data a receiver are stored in a revocation list (cancelling list). Into this revocation list, data of receivers are registered which have attracted attention by illegal distribution of contents, for instance. This revocation list is checked before the transmission of further contents to receivers. When there are data of a receiver in this list, the receiver can be excluded from the reception of further contents.

The data block is transmitted to the receiver in an asymmetrically or receiver specifically encoded form. This means that the data block can be used only by the designated receivers even when the data blocks of all the receivers are transmitted via a public channel, like a satellite transmitter, for instance The data block is encoded with the public key of the receiver and transmitted to the receiver The receiver decodes the data block with its private key and uses the data block in the decoding of the content. Alternatively, a symmetric encoding and decoding with previous stipulation of the symmetric key can take place instead of the asymmetric one. The advantage of the realisation according to the present invention is that the processing of the data block can be bound to the receiver The transport of the data block via the designated receiver is motivated, because when the receiver tries to distribute the data block illegally, he is also constrained to distribute its private key

At least a part of the data blocks is coupled to an asymmetric or receiver specific key, respectively, via a multi-stage method before the transmission, and is decoded after the reception by the receiver through performing a reverse multi-stage method. This realisation enables the coupling of data blocks, which are too large for asymmetric encoding or receiver specific encoding, respectively, to the asymmetric key or the receiver specific key, respectively. A part of a data block, for instance, is encoded with a small key Thereafter, this small key is asymmetrically encoded or receiver specifically encoded, respectively. The receiver decodes the small key in an asymmetric or receiver specific way, respectively, and then it decodes the encoded part of the data block with the aid of the small key

At least a part of the processing steps which lead to the reception of the key for decoding the content is performed in a secured hardware at the receiver. This compels that the data block is processed by the secured hardware of the receiver. Only a successful attack against the hardware of the receiver breaks this necessity, without which the receiver would be able to directly illegally distribute the encoded data The asymmetric decoding or receiver specific decoding, respectively, of the data block is performed in a secured hardware, for instance. This realisation is advantageous because asymmetric, device-specific keys in a secured hardware become more and more widespread.

A Trusted Platform Module (TPM, see https://www.trustedcomputingroup.org) is used as the secured hardware. This realisation is advantageous because the functionality of a IPM is suited for this task and the trusted computing has chances to be established as standard for a security technology in PC's and other apparatuses.

### BRIEF DESCRIPTION OF THE SEVERAL VIEWS OF THE DRAWINGS

FIG. 1 is a schematic block diagram of a Petri net

FIG. 2 is a schematic block diagram of a Petri net.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

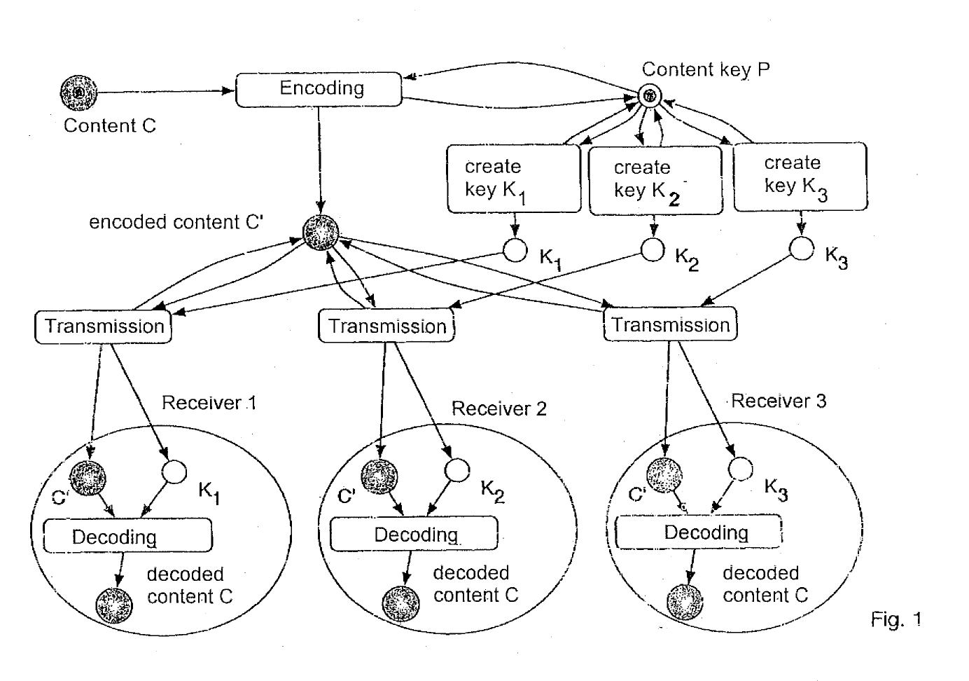

FIG. 1 represents a Petri net. A content C is decoded to C′ with a content key P. Keys K₁, K₂ and K₃ differing from each other are created from the content key P and are transmitted with the encoded content C′ to the receivers 1, 2 and 3. The receivers 1, 2 and 3 decode the encoded content with the key K₁, K₂ or K₃, respectively

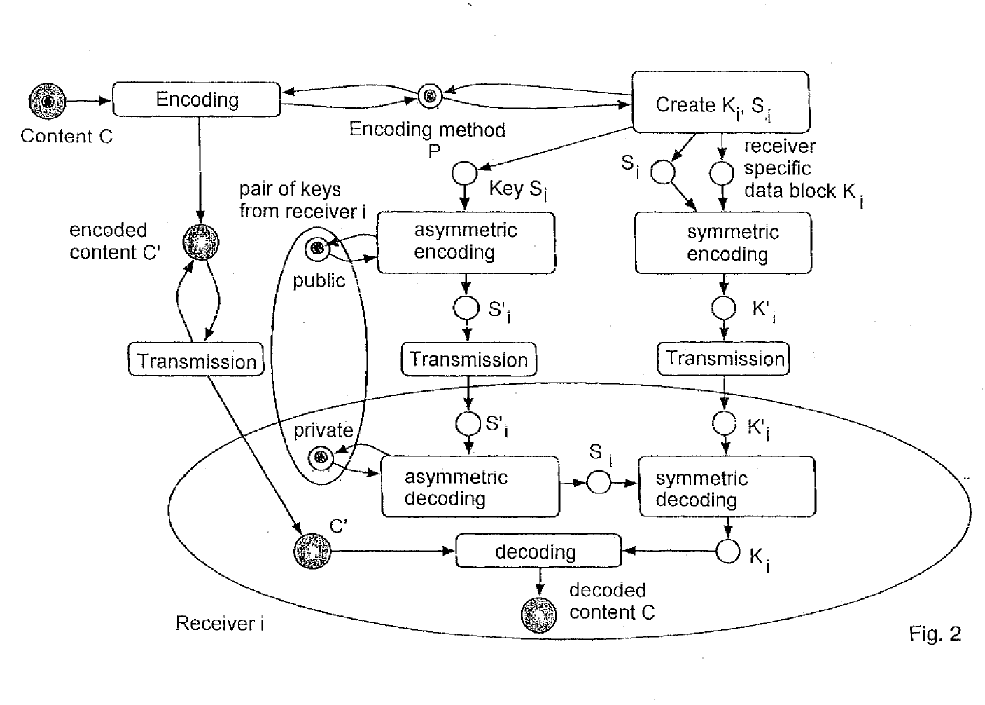

FIG. 2 represents also a Petri net. A content C is encoded to C′ with an encoding method P From the encoding method P, receiver specific data blocks Kᵢ are created, which contain receiver specific functions These functions are reverse functions of P for the greatest part of its definition range. Only for a very small part of the definition range, this is not the case. The dimension of this part of the definition range is selected to be as small that the probability at which a content encoded with P is erroneously decoded is negligibly small. Only certain test contents, which are preferably only known to the content provider, lead to receiver specific decoding errors, based on which the receiver can be identified. Besides to the creation of the data block Kᵢ, the content provider creates a symmetric key Sᵢ. With the aid of Sᵢ, the content provider encodes Kᵢ to K′ᵢ. The content provider encodes Sᵢ to S′ᵢ with the aid of the public key of the receivers as long as this public key is not listed in the revocation list of the content provider. The content provider stores the public key of the receiver i together with the data block Kᵢ in a database C′, S′ᵢ and K′ᵢ are transmitted to the receiver i The receiver i decodes S′ᵢ to Sᵢ with the aid of its private key, and then K′ᵢ to Kᵢ with the aid of Sᵢ. With the aid of Kᵢ, the receiver i decodes the encoded content C′ to C. If the receiver i distributes the data block Kᵢ and the distribution is detected by the content provider, the content provider examines the receiver specific function which is contained in the data block Kᵢ. When the input/output behaviour of the function for the test contents is coincident with the behaviour of a function which is contained in a data block which is stored in the database, the content provider registers the public key of the receiver stored in the database with respect to this data block in a revocation list No more data blocks are transmitted to a receiver having this public key.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims) In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below

This completes the description of the preferred and alternate embodiments of the invention Those skilled in the art may recognize other equivalents to the specific embodiment described herein which equivalents are intended to be encompassed by the claims attached hereto.

What is claimed is:

1. A method for the distribution of a content, characterised in that an encoded content is received by at least two receivers and is decoded with the aid of data blocks which differ from each other, wherein the encoding of the content is not receiver specific or receive group specific, and the data blocks, the assignment thereof to the receivers and the procedure of the direct decoding of the content are receiver specific or receiver group specific.

2. A method according to claim 1, characterised in that a change of the receiver specific or receiver group specific property of the data blocks is made difficult.

3. A method according to claim 1, characterised in that a receiver specific or receiver group specific property of the decoding method for the content can be identified by an automatic method.

4. A method according to claim 1, characterised in that a receiver specific or receiver group specific property of the decoding method for the content can be identified on the basis of the input/output behaviour of the decoding method.

5. A method according to claim 1, characterised in that the decoding method or a method combined with the decoding method pastes a receiver specific or receiver group specific watermark into the content

6. A method according to claim 1, characterised in that a data block and data about the receiver or the receiver group of the data block are stored in a database.

7. A method according to claim 1, characterised in that a receiver or a receiver group is identified via the database with the aid of a data block, and data of this receiver or this receiver group are stored in a revocation list and this receiver or this receiver group are excluded from the reception of at least one further content.

8. A method according to claim 1, characterised in that before the transmission, at least a part of the data blocks is encoded asymmetrically or in a receiver specific manner, respectively, and is decoded by the receiver after the reception.

9. A method according to claim 1, characterised in that before the transmission, at least a part of the data blocks is coupled to an asymmetric or receiver specific key, respectively, via a multi-stage method, and is decoded after the reception by the receiver through performing a multi-stage method.

10. A method according to claim 9, characterised in that at least a part of a data block is encoded with the aid of a key and this key is encoded asymmetrically or in a receiver specific manner before the transmission, and is decoded by the receiver after the reception.

11. A method according to claim 1, characterised in that at least a part of the processing steps which lead to the reception of the decoded content is performed in a secured hardware at the receiver.

12. A method according to claim 11, characterised in that the asymmetric decoding or the receiver specific decoding, respectively, of the data block is performed in a secured hardware.

13. A method according to claim 11, characterised in that the secured hardware is a Trusted Platform Module (TPM).
